(19) United States
(12) Patent Application Publication
(10) Pub. No.: US 2013/0169899 A1
(43) Pub. Date: Jul. 4, 2013

(54) LIQUID CRYSTAL DISPLAY DEVICE

(71) Applicants: Hiroki TSUDA, Ishikawa-ken (JP); Kazuhiro Joten, Ishikawa-ken (JP)

(72) Inventors: Hiroki TSUDA, Ishikawa-ken (JP); Kazuhiro Joten, Ishikawa-ken (JP)

(73) Assignee: Japan Display Central Inc., Fukaya-shi (JP)

(21) Appl. No.: 13/680,635

(22) Filed: Nov. 19, 2012

(30) Foreign Application Priority Data
Dec. 28, 2011 (JP) 2011-287802

(51) Int. Cl. G02F 1/133

(52) U.S. Cl. CPC G02F 1/13306
USPC 349/42

(57) ABSTRACT

A liquid crystal display device includes a plurality of pixels arranged in a matrix and constituted by first and second substrates and a liquid crystal layer held therebetween. The first substrate includes a common electrode arranged in common to the plurality of pixels, an insulating film arranged on the common electrode, a pixel electrode arranged facing the common electrode through the insulating film. Slits are formed in the pixel electrode. The liquid crystal layer is formed of a liquid crystal material having a voltage maintain rate larger than 90% in a period of 500 msec at temperature 60° C. and a rotational viscosity less than 90 mPa-s at temperature 25° C.

### CROSS-REFERENCE TO RELATED APPLICATION

This application is based upon and claims the benefit of priority from prior Japanese Patent Application No. 2011-287802, filed Dec. 28, 2011, the entire contents of which are incorporated herein by reference.

### FIELD

Embodiments described herein relate generally to a liquid crystal display device.

### BACKGROUND

A liquid crystal display device is used in various fields as displays for an OA equipment such as a personal computer, and a television receiver taking advantage of the features of a light weight, a thin shape, and a low power consumption. In recent years, the liquid crystal display device is used also as displays for personal digital assistants such as a cellular phone, a car navigation equipment, and a game machine.

In recent years, the liquid crystal display panel in the Fringe Field Switching (FFS) mode or the In-Plane Switching (IPS) mode is put in practical use. The liquid crystal display panel in the FFS mode or the IPS mode is formed of an array substrate equipped with a pixel electrode and a common electrode, the counter substrate, and a liquid crystal layer held between the array substrate and the counter substrate, and realizes switching by rotating liquid crystal molecules of the liquid crystal layer in a plane in parallel to the substrates. The display modes have advantages, such as a wide viewing angle, etc.

In the liquid crystal material applied to the display device in the FFS mode or IPS mode, various physical properties, such as a rotational viscosity rate, etc., are reviewed.

### BRIEF DESCRIPTION OF THE DRAWINGS

The accompanying drawings, which are incorporated in and constitute a portion of the specification, illustrate embodiments of the invention, and together with the general description given above and the detailed description of the embodiments given below, serve to explain the principles of the invention.

FIG. 1 is a figure schematically showing a cross-sectional structure of a liquid crystal display device according to this embodiment.

FIG. 2 is a figure showing a structure of a pixel in an array substrate shown in FIG. 1 seen from a counter substrate side.

FIGS. 3A, 3B and 3C are figures showing a state in which impurity ions contained in a liquid crystal layer are localized and a state in which the localized state is relaxed.

FIG. 4 is a figure showing a voltage maintain rate about each of liquid crystal materials A, B, C and D.

FIG. 5 is a figure showing a rotation viscosity about each of the liquid crystal materials A, B, C and D.

FIG. 6 is a figure showing a surface tension about each of the liquid crystal materials A, B, C and D.

FIG. 7 is a figure showing a measurement result of an experiment for reproducing a burn-in phenomenon.

### DETAILED DESCRIPTION

A liquid crystal display device according to an exemplary embodiment of the present invention will now be described with reference to the accompanying drawings wherein the same or like reference numerals designate the same or corresponding portion s throughout the several views.

According to one embodiment, a liquid crystal display device including a plurality of pixels arranged in a matrix includes: a first substrate including; a switching element arranged in each pixel, a common electrode arranged in common to the plurality of pixels, an insulating film arranged on the common electrode, a pixel electrode arranged facing the common electrode on the insulating film, a slit being formed in the pixel electrode, and a first alignment film covering the pixel electrode, an alignment treatment being performed to the first alignment film in a direction crossing a long axis of the slit; a second substrate having a second alignment film facing the first alignment film, an alignment treatment being performed to the second alignment film in a direction in parallel and opposite to the first alignment film each other; and a liquid crystal layer including liquid crystal molecules and held between the first alignment film on the first substrate and the second alignment film on the second substrate; wherein the liquid crystal layer is formed of a liquid crystal material having a voltage maintain rate larger than 90% in a period of 500 msec at temperature 60° C. and a rotational viscosity less than 90 mPa·s at temperature 25° C.

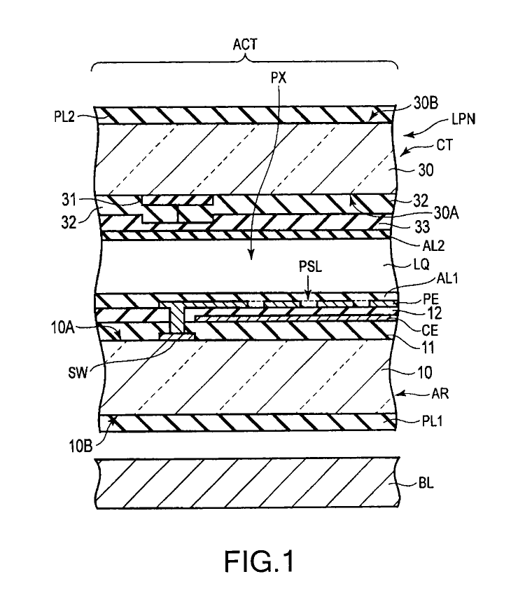

FIG. 1 is a figure schematically showing a cross-sectional structure of the liquid crystal display device according to this embodiment.

The liquid crystal display device is equipped with a transmissive active-matrix type liquid crystal display panel LPN. The liquid crystal display panel LPN is equipped with an array substrate AR which is a first substrate, a counter substrates CT which is a second substrate facing the array substrate AR, and a liquid crystal layer LQ held therebetween. The liquid crystal display panel LPN is equipped with an active area ACT which displays images. Although the active area ACT is constituted by a plurality of pixels PX, only one pixel is shown in FIG. 1.

The liquid crystal display panel LPN of the illustrated example is applicable to the FFS mode or the IPS mode, and includes a pixel electrode PE and a common electrode CE in the array substrate AR. In the liquid crystal liquid crystal display panel LPN, liquid crystal molecules which constitute the liquid crystal layer LQ are switched mainly using horizontal electric field (for example, electric field almost in parallel to the principal surface of the substrate in the fringe electric field) formed between the pixel electrode PE and the common electrode CE.

The array substrate AR is formed using a first insulating substrate 10 such as a glass substrate which has light transmissive characteristics. The array substrate AR is equipped with a switching element SW and the pixel electrode PE arranged in each pixel PX, the counter electrode CE arranged in common to a plurality of pixels and a first alignment film AL1 on an inner surface 10A (namely, the side facing the counter substrate CT) of the first insulating substrate 10, other than a gate line and a source line which are not shown.

The switching element SW is formed of a thin film transistor (TFT) and electrically connected with the gate line and the source line. The switching element SW is equipped with a semiconductor layer formed of poly-silicon or amorphous silicon. In addition, the switching elements SW may be any of a top-gated type and a bottom-gated type. The switching elements SW is covered with a first insulating film 11.

The common electrode CE is arranged on the first insulating film 11. The common electrode CE is formed by transparent electric conductive materials, such as Indium Tin Oxide (ITO), Indium Zinc Oxide (IZO), etc. The common electrode CE is covered with a second insulating film 12. Moreover, the second insulating film 12 is arranged also of the first insulating film 11.

The pixel electrode PE is arranged on the second insulating film 12, and faces the common electrode CE. The pixel electrode PE is electrically connected with the switching element SW through a contact hole which penetrates the first insulating film 11 and the second insulating film 12. Moreover, a plurality of slits PSL which faces the common electrode CE through the second insulating film 12 is formed in the pixel electrode PE. The pixel electrode PE is formed by transparent electric conductive material, for example, ITO, IZO, etc. The pixel electrode PE is covered with a first alignment film AL1. Moreover, the first alignment film AL1 is arranged also on the second insulating film 12. The first alignment film AL1 is formed of materials (for example, polyimide) which shows a horizontal alignment characteristics, and is arranged on a plane of the array substrate AR which touches the liquid crystal layer LQ.

On the other hand, the counter substrate CT is formed using a second insulating substrate 30 such as a glass substrate, which has light transmissive characteristics. The counter substrate CT is equipped with a black matrix 31, a color filter 32, an overcoat layer 33, and a second alignment film AL2 in an inside surface 30A of the second insulating substrate 30 (namely, the side facing the array substrate AR).

In the inside surface 30A of the second insulating substrate 30, the black matrix 31 is formed so that the black matrix 31 counters with line portions such as the gate line G, the source line S, and the switching element SW arranged in the array substrate AR, and defines each pixel PX.

The color filter 32 is formed in the inside surface 30A of the second insulating substrate 30 extending also on the black matrix 31. The color filter 32 is formed of resin materials colored in several mutually different colors, for example, red, green and blue, i.e., three primary colors, respectively. The boundaries between the color filters 32 of the different colors are located on the black matrix 31.

The overcoat layer 33 covers the color filter 32. The overcoat layer 33 makes flat unevenness of the surface of the black matrix 31 or the color filter 32. The overcoat layer 33 is formed of transparent resin materials. Moreover, the overcoat layer 33 is covered with the second alignment film AL2. The second alignment film AL2 is formed of materials which show a horizontal alignment characteristics, and is arranged on the surface of the counter substrate CT which touches the liquid crystal layer LQ.

The array substrate AR and the counter substrate CT mentioned above are arranged so that the first alignment film AL1 and the second alignment film AL2 face each other. At this time, a predetermined cell gap is formed by a pillar-shaped spacer formed integrally with one of the substrates between the array substrate AR and the counter substrate CT. The array substrate AR and the counter substrate CT are pasted together by seal material while the cell gap is formed. The liquid crystal layer LQ is constituted by the liquid crystal material containing the liquid crystal molecule injected in the cell gap formed between the first alignment film AL1 of the array substrate AR and the second alignment film AL2 of the counter substrate CT. For example, the liquid crystal layer LQ is constituted by a positive type liquid crystal material.

A backlight BL is arranged on the back side of the liquid crystal display panel LPN in the illustrated example. Various types of backlights BL can be used. For example, a light emitting diode (LED) or a cold cathode fluorescent lamp (CCFL), etc., can be applied as a light source of the backlight BL, and the explanation about its detailed structure is omitted.

A first polarizing plate PL1 having a first absorption axis is arranged on an external surface of the array substrate AR, i.e., an external surface 10B of a first insulating substrate 10. Moreover, a second polarizing plate PL2 having a second absorption axis is arranged on an external surface 30B of the counter substrate CT, i.e., the external surface of a second insulating substrate 30. The first absorption axis of the first polarizing plate PL1 and the second absorption axis of the second polarizing plate PL2 are arranged in Cross-Nicol positional relationship, for example. In addition, other optical elements, such as a retardation film, may be arranged between the first insulating substrate 10 and the first polarizing plate PL1, and between the second insulating substrate 30 and the second polarizing plate PL2.

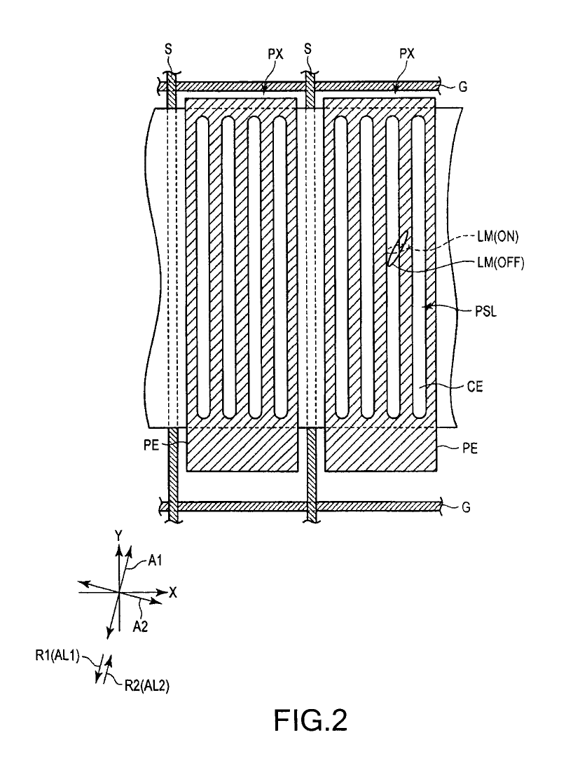

FIG. 2 is a figure showing a structure of a pixel in the array substrate AR shown in FIG. 1 seen from the counter substrate CT side.

Gate lines G extend along the first direction X, respectively. The gate lines G are arranged with a first pitch along the second direction Y. The source lines S extend along the second direction Y, respectively. The source lines S are arranged with a second pitch smaller than the first pitch along the first direction X. The pixel PX formed with the gate lines G and the source lines S has a rectangle shape whose length in the first direction X is shorter than the length in the second direction Y. That is, the length in the second direction Y of the pixel PX corresponds to the first pitch between the gate lines G, and the length in the first direction X of the pixel PX corresponds to the second pitch between the source lines S. In addition, though the switching element is arranged in the intersection of the gate line G and the source line S, the arrangement is not shown.

The common electrode CE extends in the first direction X. That is, while the common electrode CE is formed in each pixel PX, the common electrode CE is arranged in common striding over the source lines S and facing a plurality of pixels PX which adjoin in the first direction X. Moreover, although not illustrated, the common electrode CE may be formed in common to a plurality of pixels PX which adjoin in the second direction Y.

The pixel electrode PE of each pixel PX is arranged above the common electrode CE. Each pixel electrode PE is formed in the shape of an island corresponding to a rectangular pixel form in each pixel PX. In the illustrated example, the pixel electrode PE is formed substantially in the shape of the rectangle which has a short side in the first direction X, and a long side in the second direction Y. A plurality of slits PSL which faces the common electrode CE is formed in each pixel electrode PE. In the illustrated example, each of the slits PSL extends along the second direction Y, and has a long axis in parallel to the second direction Y.

Alignment treatment (for example, rubbing processing and optical alignment processing) of the first alignment film AL1 and the second alignment film AL2 is carried out on a surface in parallel with the substrate surface (or X-Y plane), respectively. The alignment treatment of the first alignment film AL1 is carried out along a direction which intersects the long axis of the slit PSL (the second direction Y in the example shown in FIG. 2) with an acute angle of 45° or less. The alignment treatment direction R1 of the first alignment film AL1 is a direction crossing the second direction Y with an angle of 5°-15°, for example. Moreover, the alignment treatment of the second alignment film AL2 is carried out along a direction in parallel to the alignment treatment direction R1 of the first alignment film AL1. The alignment treatment direction R1 of the first alignment film AL1 and the alignment treatment direction R2 of the second alignment film AL2 are opposite, each other.

Hereinafter, the operation in the liquid crystal display device of the above-mentioned structure is explained.

At the time of OFF when voltage is not impressed between the pixel electrode PE and the common electrode CE, that is, electric field is not formed between the pixel electrode PE and the common electrode CE, the liquid crystal molecule LM contained in the liquid crystal layer LQ is initially aligned in the X-Y plane as shown in a solid line in FIG. 2. The direction in which the liquid crystal molecule LM initially aligns is called an initial alignment direction. In addition, the first absorption axis A1 of the first polarizing plate PL1 or the second absorption axis A2 of the second polarizing plate PL2 is the direction substantially in parallel with the initial alignment direction of the liquid crystal molecule LM. The first absorption axis A1 of the first polarizing plate PL1 or the second absorption axis A2 of the second polarizing plate PL2 is a direction substantially in parallel with the initial alignment direction. In the example shown in FIG. 2, the first absorption axis A1 is substantially in parallel with the initial alignment direction, and the second absorption axis A2 crosses the initial alignment direction substantially at right angles.

At the time of OFF, a portion of the backlight from the backlight BL penetrates the first polarizing plate PL1, and enters into the liquid crystal display panel LPN. The light which entered into the liquid crystal display panel LPN is a linearly polarized light which intersects perpendicularly with the first polarization axis of the first polarizing plate PL1. The polarization state of the linearly polarized light hardly changes when the light passes the liquid crystal display panel LPN at the time of OFF. For this reason, the linearly polarized light which penetrated the liquid crystal display panel LPN is absorbed by the second polarizing plate PL2 which is arranged in Cross Nicol positional relationship with the first polarizing plate PL1 (black display).

On the other hand, at the time of ON when voltage is impressed between the pixel electrode PE and the common electrode CE, that is, the fringe electric field is formed between the pixel electrode PE and the common electrode CE, the liquid crystal molecule LM is aligned in a different direction from the initial direction in the X-Y plane as shown in a dashed line in FIG. 2. In a positive type liquid crystal material, the liquid crystal molecule LM is aligned so that the long axis of the liquid crystal molecule directs in a direction substantially in parallel with the electric field in the X-Y plane.

At the time of such ON, the linearly polarized light which intersects perpendicularly with the first polarization axis of the first polarizing plate PL1 enters into the liquid crystal display panel LPN, and the polarized state changes according to the alignment state of the liquid crystal molecule LM when the light passes the liquid crystal layer LQ. For this reason, at the time of ON, at least a portion of the light which passed the liquid crystal layer LQ penetrates the second polarizing plate PL2 (white display).

Next, the relation of the physical properties of the liquid crystal layer LQ and a driving method according to this embodiment is reviewed.

In the above-mentioned FFS mode and IPS mode, the liquid crystal display device uses the array substrate AR equipped with the pixel electrode PE and the common electrode CE. Therefore, impurity ions (or electric charge) contained in the liquid crystal layer LQ are attracted to the surface of the array substrate AR, then adsorbed to the first alignment film AL1, and localized. That localized state is hard to be relaxed. In the state where the impurities are localized, even if it is in the state where the voltage is not impressed between the pixel electrode and the common electrode, it may be in the state where a DC voltage is locally impressed to the liquid crystal layer LQ, and there is a possibility of causing deterioration of display grace, i.e., what is called burn-in phenomenon.

It is difficult to remove the impurity ions in the liquid crystal layer LQ completely to improve such state. Accordingly, in this embodiment, the amount of impurity ions is reduced as much as possible, and the state where the impurity ions are localized is relaxed more shortly.

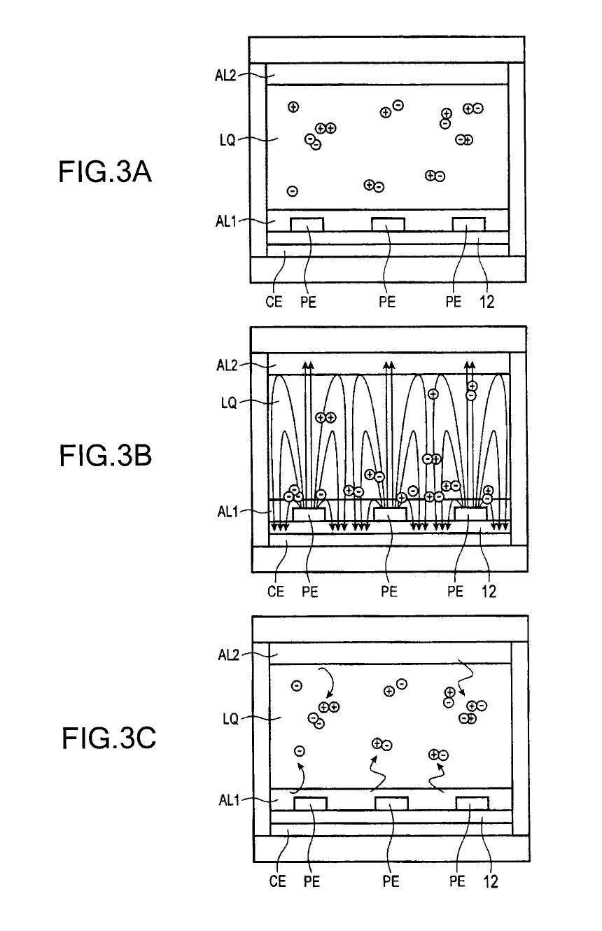

FIGS. 3A, 3B and 3C are figures showing a state in which impurity ions contained in the liquid crystal layer are localized and a state in which the localized state is relaxed.

That is, as shown in FIG. 3A, the impurity ions (shown by + or − in the figure) exist in the liquid crystal layer LQ arranged between the first alignment film AL1 and the second alignment film AL2 not a little. In the state where voltage is not impressed between the pixel electrode PE and the common electrode CE, the impurity ions are dispersed in the liquid crystal layer LQ.

As shown in FIG. 3B, in a state where potential difference is formed between the pixel electrode PE and the common electrode CE, the fringe electric field which directs to the common electrode CE from the pixel electrode PE is formed. Under the influence of the fringe electric field and a dipole moment of the liquid crystal material, the impurity ions dispersed in the liquid crystal layer LQ are attracted to near the surface of the array substrate AR, and the impurity ions are localized on the first alignment film AL1 by being adsorbed on the first alignment film AL1.

As shown in FIG. 3C, when the display panel returns to the state where the voltage is not impressed between the pixel electrode PE and the common electrode CE, the fringe electric field and the dipole moment of the liquid crystal material are removed. Accordingly, the impurity ions attract each other by coulomb force, and the state in which the impurity ions are localized changes to a relaxed state. The impurity ions are affected by the influence of rotational viscosity resistance of the liquid crystal material at this time. Therefore, when the viscosity of the liquid crystal material is high, the state in which the impurity ions are localized is hard to be relaxed by receiving the viscosity resistance higher than the coulomb force between impurity ions. As a consequence, the above burn-in phenomena occurs.

So, in this embodiment, its attention was first paid to a voltage maintain rate (VHR) as one of the physical properties of the liquid crystal material. In the liquid crystal display device, it is necessary to make small leak current between the pixel electrode PE and the common electrode CE and to hold electric charges in a fixed period in order to display the picture with high contrast ratio. The voltage maintain rate (%) corresponds to a ratio (VB/VA) between a pulse voltage VA impressed between the pixel electrode PE and the common electrode CE and a voltage VB currently held in the liquid crystal layer LQ after a fixed period (for example, one frame period) has passed. For example, the value is measured by a measuring method defined by JEITA (The Japan Electronics and Information Technology Industries Association) standard: ED-2521B (measuring method of a liquid crystal display panel and its composition material).

The lowering of the voltage maintain rate is dependent on the quantity of the impurity ions contained in liquid crystal material. That is, when many impurity ions are contained in the liquid crystal material, many impurity ions are adsorbed to the surface of the first alignment film AL1. The influence of electric field in an opposite direction to that originally impressed to the liquid crystal layer LQ becomes larger with increase of the adsorbed impurities, and the phenomenon in which the voltage maintain rate falls is checked. That is, the liquid crystal material with a high voltage maintain rate means that there is fewer amount of impurity ions. In this embodiment, the liquid crystal material is used in which the voltage maintain rate in a period 16.67 msec is larger than 99% at temperature 60° C. which is high temperature environment, moreover, the voltage maintain rate in a period 500 msec is larger than 90% at temperature 60° C.

Moreover, in this embodiment, its attention is paid to a rotational viscosity (γ1) as one of the physical properties of the liquid crystal material. As explained with reference to FIGS. 3A, 3B and 3C, when the pixel PX returns to the state where the voltage is not impressed between the pixel electrode PE and the common electrode CE, it is required that the viscosity resistance of the liquid crystal material is fully reduced rather than the coulomb force between impurity ions in order to make the impurity ions localized on the first alignment film AL1 disperse in the liquid crystal layer LQ quickly. The rotational viscosity is a value measured by the measuring method defined by the JEITA standard ED-2521B (liquid crystal display panel and its composition material), for example.

The liquid crystal material with small rotational viscosity means that the viscosity resistance of the material is small, and that the relaxation of the impurity ions is hard to be bared (or diffusion of impurity ions is promoted). In this embodiment, the liquid crystal material is used, in which the rotational viscosity is smaller than 90 mPa-s, and more desirably, smaller than 80 mPa-s at temperature 25° C.

However, the rotational viscosity of the liquid crystal material would not be made small without limit, and would be saturated with the rotational viscosity of a certain value by restrictions on compositions or molecular structures of the liquid crystal material. Moreover, it is possible to lower the rotational viscosity by increasing volatile material contained in the liquid crystal material. However, volatile material may be volatized in the process in which the liquid crystal display panel LPN is manufactured, and may result in a fault of the manufacturing equipment or generation of air bubbles in the liquid crystal layer LQ of the manufactured liquid crystal display panel LPN. Therefore, it is not desirable to include much volatile material in the liquid crystal material without limit. According to this embodiment, it is desirable to use the liquid crystal material in which the rotational viscosity is larger than 70 mPa-s at temperature 25° C. from above viewpoints.

Moreover, in this embodiment, its attention was paid to surface tension as one of the physical properties of the liquid crystal material. The surface tension of the liquid crystal material here corresponds to wettability to the alignment film. In order to avoid the burn-in phenomenon, it is necessary to make hard that the impurity ions are adsorbed to the surface of the first film AL1, when the electric field is formed between the pixel electrode PE and the common electrode CE. Furthermore, when the cell returns to the state where the voltage is not impressed between the pixel electrode PE and the common electrode CE, it is necessary to make a surface energy large between the liquid crystal layer LQ and first alignment film AL1 in order to make the impurity ions adsorbed to the first alignment film AL1 in the liquid crystal layer LQ disperse quickly. That is, it is required to make high the wettability of the liquid crystal material to the alignment film. The liquid crystal material with small surface tension to the alignment film means that the wettability to the alignment film is high. In this embodiment, the liquid crystal material whose surface tension is smaller than 30 dyn/cm is applied.

Next, four liquid crystal materials (liquid crystal materials A, B, C and D) were prepared, and the liquid crystal cell of simple structure was manufactured. Then, the existence of the burn-in phenomenon was checked.

First of all, respective physical properties are explained about the prepared liquid crystal materials A to D.

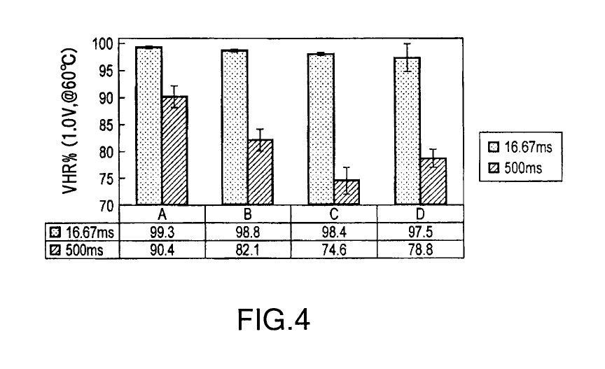

FIG. 4 is a figure showing the voltage maintain rate about each of the liquid crystal materials A to D. Here, the respective voltage maintain rates in the period 16.67 msec and period 500 msec at temperature 60° C. about each liquid crystal materials are shown.

At temperature 60° C., about the voltage maintain rate in the period 16.67 msec, although the liquid crystal material A was 99.3%, the liquid crystal material B was 98.8%, the liquid crystal material C was 98.4%, and the liquid crystal material D was 97.5%. Although most of the liquid crystal materials were not less than 98%, only the liquid crystal material A was over 99%.

Regarding the voltage maintain rate in the period 500 msec at temperature 60° C., the liquid crystal material A was 90.4%, the liquid crystal material B was 82.1%, the liquid crystal material C was 74.6%, the liquid crystal material D was 78.8%. Though there was a large difference among the liquid crystal materials, only the liquid crystal material A was over 90%.

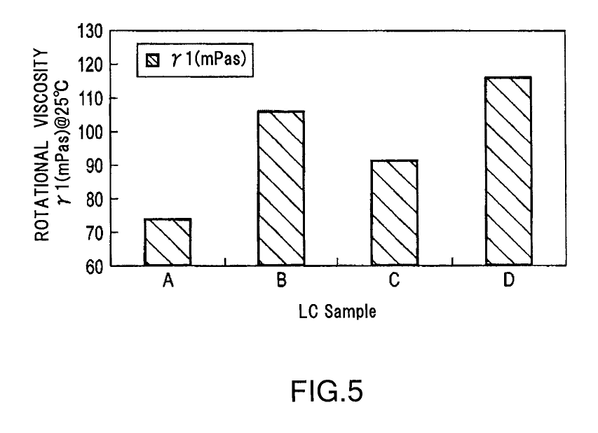

FIG. 5 is a figure showing the rotational viscosity about each of the liquid crystal materials A to D. Here, the rotational viscosity at the temperature o 25° C. is shown. The liquid crystal material A was 74 mPa-s, the liquid crystal material B was 106 mPa-s, the liquid crystal material C was 91 mPa-s, the liquid crystal material D was 115 mPa-s. Though there was a large difference among the liquid crystal materials, only the liquid crystal material A was less than 80 mPa-s.

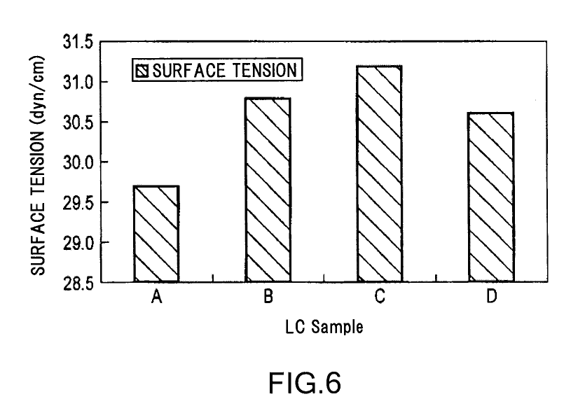

FIG. 6 is a figure showing the surface tension about each of the liquid crystal materials A to D. The liquid crystal material A was 29.7 dyn/cm, the liquid crystal material B was 31 dyn/cm, the liquid crystal material C was 31.2 dyn/cm, the liquid crystal material D was 30.6 dyn/cm. Only the liquid crystal material A was less than 30 dyn/cm.

The experiment for reproducing the burn-in phenomenon is performed using the liquid crystal materials A to D with above physical properties.

First, a voltage which displays a gray level (gradient L127) is impressed to the liquid crystal cell of the simple structure, and has been held for 30 minutes. In such state, a luminosity of the gray level in a fixed point is measured with a luminance meter every 10 minute.

For 60 minutes after that, a voltage which displays black (gradient LO) is impressed to the liquid crystal cell. In the meantime, the cell is returned to the state where the voltage of the gray level is impressed every 10 minute, and the luminosity of the gray level in the fixed point is measured.

For 30 minutes after that, the voltage which displays the gray level is impressed to the liquid crystal cell, and this state is held. Also, in the meantime, the luminosity of the gray level in the fixed point is measured every 10 minute. The luminosity measured through the above process is called a black color burn-in luminosity.

On the other hand, first, the voltage which displays the gray level (gradient L127) is impressed to the liquid crystal cell of the simple structure, and has been held for 30 minutes. In such state, the luminosity of the gray level in the fixed point is measured with the luminance meter every 10 minute.

For 60 minutes after that, a voltage which displays white (gradient L255) is impressed to the liquid crystal cell. In the meantime, the cell is returned to the state where the voltage of the gray level is impressed to the liquid crystal cell every 10 minute, and the luminosity of the gray level in the fixed point is measured.

For 30 minutes after that, the voltage which displays the gray level is impressed to the liquid crystal cell, and the state is held. The luminosity of the gray level in the fixed point is measured every 10 minute also in the meantime. The luminosity measured through the above process is called a white color burn-in luminosity.

Then, the luminosity difference between the black color burn-in luminosity and the white color burn-in luminosity is calculated. The rate of the computed luminosity difference to an initial luminosity at the time when the voltage of the gray level is started to be impressed is defined as a luminosity change rate (%).

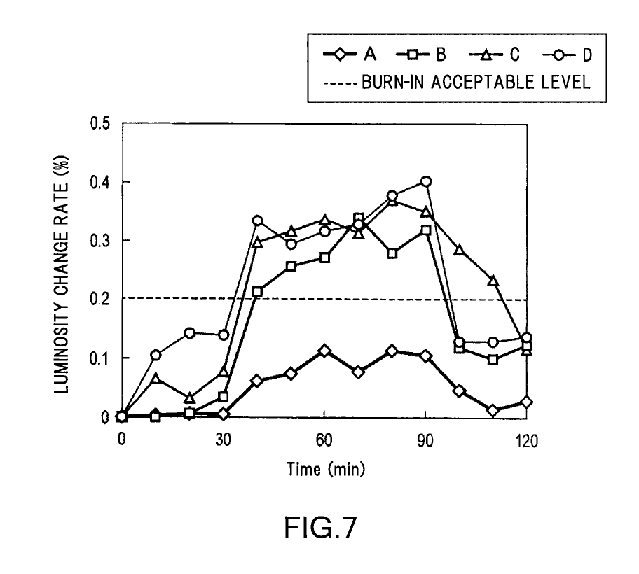

FIG. 7 is a figure showing a measurement result of the experiment for reproducing the burn-in phenomenon.

The horizontal axis in the figure shows lapsed time (min), and the vertical axis in the figure shows luminosity change rate (%).

The maximum of the luminosity change rate of the liquid crystal material A was 0.1%, the maximum of the luminosity change rate of the liquid crystal material B was 0.3%, the maximum of the luminosity change rate of the liquid crystal material C was 0.32%, and the maximum of the luminosity change rate of the liquid crystal material D was 0.4%. As a level in which the burn-in phenomenon is not sighted, although it is required that the luminosity change rate is less than 0.2% and more desirably less than 0.1%, it was checked that only the liquid crystal material A can clear such conditions.

As explained above, in this embodiment, the liquid crystal material A which fulfills the following conditions is used: the voltage maintain rate in the period 500 msec is larger than 90% at temperature 60° C. which is high temperature environment, the rotational viscosity at temperature 25° C. is smaller than 80 mPa-s, and the surface tension is smaller than 30 dyn/cm. Therefore, it becomes possible to control generating of the burn-in phenomenon.

As explained above, according to this embodiment, the liquid crystal display device which can improve the display grace can be supplied.

In the above-mentioned embodiment, though the slit PSL of the pixel electrode PE is formed so that the slit SL has a long axis in parallel to the second direction Y, the slit SL may be formed so that the slit SL has the long axis in parallel to the first direction X. Further, the slit PSL of the pixel electrode PE may be formed so that the slit PSL has a long axis in parallel to a direction which crosses the first direction X and the second direction Y, respectively, and also may be formed in a crooked shape.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device including a plurality of pixels arranged in a matrix, comprising:
a first substrate including;
a switching element arranged in each pixel,
a common electrode arranged in common to the plurality of pixels,
an insulating film arranged on the common electrode,
a pixel electrode arranged facing the common electrode on the insulating film, a slit being formed in the pixel electrode, and
a first alignment film covering the pixel electrode, an alignment treatment being performed to the first alignment film in a direction crossing a long axis of the slit;
a second substrate having a second alignment film facing the first alignment film, an alignment treatment being performed to the second alignment film in a direction in parallel and opposite to the first alignment film each other; and
a liquid crystal layer including liquid crystal molecules and held between the first alignment film on the first substrate and the second alignment film on the second substrate; wherein
the liquid crystal layer is formed of a liquid crystal material having a voltage maintain rate larger than 90% in a period of 500 msec at temperature 60° C. and a rotational viscosity less than 90 mP-as at temperature 25° C.

2. The liquid crystal display device according to claim 1, wherein the rotational viscosity is larger than 70 mPa-s at temperature 25° C.

3. The liquid crystal display device according to claim 1, wherein a surface tension of the liquid crystal material is smaller than 30 dyn/cm.

4. The liquid crystal display device according to claim 1, wherein the rotational viscosity is less than 80 mPa-s at temperature 25° C.

5. The liquid crystal display device according to claim 1, further comprising;
a first polarizing plate arranged on an outer surface of the first substrate and having a first absorption axis, and
a second polarizing plate arranged on an outer surface of the second substrate and having a second absorption axis, the second absorption axis being arranged in a Cross Nicol positional relationship with the first absorption axis.

6. The liquid crystal display device according to claim 5, wherein the first absorption axis or the second absorption axis is substantially in parallel with an initial alignment direction of the liquid crystal molecules.

7. The liquid crystal display device according to claim 1, wherein the liquid crystal display device is driven by the FFS mode or the IPS mode.

8. A liquid crystal display device including a plurality of pixels arranged in a matrix, comprising,
a first substrate including;
a switching element arranged in each pixel;
a common electrode arranged in common to the plurality of pixels,
an insulating film arranged on the common electrode,
a pixel electrode arranged facing the common electrode on the insulating film, a slit being formed in the pixel electrode, and
a first alignment film covering the pixel electrode, an alignment treatment being performed to the first alignment film in a direction crossing a long axis of the slit;
a second substrate having a second alignment film facing the first alignment film, an alignment treatment being performed to the second alignment film in a direction in parallel and opposite to the first alignment film each other;
a liquid crystal layer including liquid crystal molecules and held between the first alignment film on the first substrate and the second alignment film on the second substrate;
a first polarizing plate arranged on an outer surface of the first substrate and having a first absorption axis; and
a second polarizing plate arranged on an outer surface of the second substrate and having a second absorption axis, the second absorption axis being arranged in a Cross Nicol positional relationship; wherein
the liquid crystal layer is formed of a liquid crystal material having a voltage maintain rate larger than 90% in a period of 500 msec at temperature 60° C., a rotational viscosity less than 90 mPa-s and larger than 70 mPa-s at temperature 25° C., and a surface tension smaller than 30 dyn/cm.

9. The liquid crystal display device according to claim 8, wherein the rotational viscosity is less than 80 mPa-s at temperature 25° C.

10. The liquid crystal display device according to claim 8, wherein the first absorption axis or the second absorption axis is substantially in parallel with an initial alignment direction of the liquid crystal molecules.

11. The liquid crystal display device according to claim 8, wherein the liquid crystal display device is driven by the FFS mode or the IPS mode.
